(19) United States
(12) Patent Application Publication
(10) Pub. No.: US 2023/0321813 A1
(43) Pub. Date: Oct. 12, 2023

(54) ROBOTIC PLATFORM WITH DUAL TRACK

(71) Applicant: Off-World, Inc., Altadena, CA (US)

(72) Inventors: Thibaud Talon, Los Angeles, CA (US); Alicia Teresa Kavelaars, Berkeley, CA (US); Qiaozhi Wang, Los Angeles, CA (US); Piyush Patil, Los Angeles, CA (US); Vladimir Pena, Los Angeles, CA (US); Sergio Pieiga, III, Los Angeles, CA (US); Ashish Kumar, Los Angeles, CA (US); Arjun Muthuvelu, Los Angeles, CA (US); Thayjes Srivas, Los Angeles, CA (US); Mantas Gribulis, San Francisco, CA (US)

(21) Appl. No.: 18/296,526

(22) Filed: Apr. 6, 2023

Related U.S. Application Data
(60) Provisional application No. 63/362,652, filed on Apr. 7, 2022.

(51) Int. Cl. B25J 5/00; B25J 9/16; B25J 9/00; B25J 19/02

(52) U.S. Cl. CPC B25J 5/005; B25J 9/162; B25J 9/0009; B25J 9/1694; B25J 19/023

(57) ABSTRACT

A robotic platform or “bot” having a dual track mobility system. The bot is unmanned and autonomous, or may be controlled via remote control. The dual track dual suspension-tension system has first and second tracks positioned along lateral sides of the bot and extending longitudinally over a plurality of rollers. The bot may include suspension arms coupled to groups of the rollers on the ground facing sides of the tracks for suspension and the non-ground facing side of the tracks for tension in the tracks. The bot can operate in a first orientation and a second, vertically opposite orientation and maintain suspension capabilities in either orientation. The bot may include a payload mounted in a payload bay and that is configured to rotate in at least two axes. The bot may include a symmetrical sensor assembly configured to operate according to a reference frame controlled via a control system.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. For example, this application claims the benefit of U.S. Provisional Application No. 63/362,652, filed on Apr. 7, 2022, titled GEOSURVEY BOT, the entire content of which is incorporated by reference herein for all purposes and forms a part of this specification.

### BACKGROUND

### Field

The disclosure relates generally to robots or “bots,” in particular to a robotic platform having dual tracks and that can invert and maintain suspension capabilities using a dual suspension-tension system. The platform can be used for surveying, navigating, and mapping extreme terrains, and other uses.

### Description of the Related Art

Machines may be used for navigating and mapping various natural environments. In some instances mobile machines such as robotic platforms are used in extreme environments with rugged terrain. Conventional robotic solutions suffer from functional deficiencies, such as the inability to continue intended motion or intended mapping, in the event that the machine flips or changes orientations during use. Therefore, there is a need for an improved solution to such robotics to address these and other drawbacks of existing solutions.

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing systems, devices, and methods relating to robotic platforms (also called robots or “bots”) for surveying and other purposes.

The following disclosure describes non-limiting examples of some embodiments. For instance, other embodiments of the disclosed device, systems and methods may or may not include the features described herein. Moreover, disclosed advantages and benefits may apply only to certain embodiments of the invention and should not be used to limit the disclosure. Systems, devices and methods are described for a robotic platform that may be used for surveying and other applications.

In one aspect, a robotic platform includes a dual track dual suspension-tension system, a first body, a second body, and a payload support. The dual track dual suspension-tension system includes a first track extending longitudinally and positioned along a first lateral side of the robotic platform and a second track extending longitudinally and positioned along a second lateral side of the robotic platform. Each track extends over a respective plurality of rollers. The first body extends laterally and connects the first track and the second track at a forward end of the robotic platform. The second body extends laterally and connects the first track and the second track at a rear end of the robotic platform. the first body, the second body, the first track and the second track define a payload bay. The payload support is configured to carry a payload. The payload support is mounted in the payload bay of the robotic platform. The payload support is mounted to each of the first body and the second body with a gimbaled mount configured to rotate the payload in at least two axes as the robotic platform changes orientation.

Various embodiments of the various aspects may be implemented. In some embodiments, the payload support is accessible from a first direction above a horizontal plane extending through the payload bay and from a second direction below the horizontal plane.

In some embodiments, the payload bay is protected by the first lateral side, the second lateral side, the first body, and the second body. A first exposed side of the payload faces in a direction opposite to an upward vertical axis.

In some embodiments, the payload support comprises a protective transparent cover configured to protect the payload.

In some embodiments, the gimbaled mount is rotationally coupled about a longitudinal axis of the robotic platform at rotational connections with the first body and the second body.

In some embodiments, the robotic platform further includes the payload, wherein the payload is rotationally coupled about a lateral axis that is perpendicular to the longitudinal axis of the robotic platform.

In some embodiments, the robotic platform further includes the payload, wherein the payload comprises a LiDAR sensor.

In some embodiments, the robotic platform is configured to operate in a first orientation and a second orientation. In the first orientation a vertical vector of the robotic platform that is perpendicular to the longitudinal and lateral directions has a component parallel with and in the same direction as a gravity vector and in the second orientation the vertical vector has a component parallel with and in the opposite direction as the gravity vector.

In some embodiments, the robotic platform rotates 180 degrees about a longitudinal axis to transition from the first orientation to the second orientation.

In some embodiments, the robotic platform flips to transition from the first orientation to the second orientation.

In some embodiments, the gimbaled mount is configured to actively rotate.

In some embodiments, the gimbaled mount is configured to passively rotate.

In another aspect, a robotic platform includes a dual track dual suspension-tension system and a symmetrical sensor assembly. The dual track dual suspension-tension system includes a first track extending longitudinally and positioned along a first lateral side of the robotic platform and a second track extending longitudinally and positioned along a second lateral side of the robotic platform. Each track extending over a respective plurality of rollers. The symmetrical sensor assembly is configured to operate according to a reference frame. The reference frame is controlled via a control system. The control system inverts the reference frame when the robotic platform transitions from a first orientation to a second orientation. In the first orientation a vertical vector of the robotic platform that is perpendicular to the longitudinal and lateral directions has a component parallel with and in an opposite direction as a gravity vector and in the second orientation the vertical vector has a component parallel with and in a same direction as the gravity vector.

Various embodiments of the various aspects may be implemented. In some embodiments, the symmetrical sensor assembly further includes a plurality of sensors symmetrically positioned about the robotic platform with respect to a horizontal plane.

In some embodiments, the symmetrical sensor assembly further includes a LiDAR sensor mounted on a tilting platform on a first body extending laterally and connecting the first track and the second track at a forward end of the robotic platform or a second body extending laterally and connecting the first track and the second track at a rear end of the robotic platform.

In some embodiments, the symmetrical sensor assembly further includes a first camera mounted a first body extending laterally and connecting the first track and the second track at a forward end of the robotic platform and a second camera mounted to a second body extending laterally and connecting the first track and the second track at a rear end of the robotic platform.

In some embodiments, the symmetrical sensor assembly further comprises a first camera mounted to the first lateral side and a second camera mounted to the second lateral side.

In some embodiments, the symmetrical sensor assembly further comprises a camera configured to view a payload bay.

In another aspect, a robotic platform includes a dual track dual suspension-tension system and a plurality of suspension arms. The dual track dual suspension-tension system includes a first track extending longitudinally and positioned along a first lateral side of the robotic platform and a second track extending longitudinally and positioned along a second lateral side of the robotic platform. Each track extending over a respective plurality of rollers. The plurality of suspension arms are coupled to groups of the respective plurality of rollers. A first vertical end of at least one of the plurality of suspension arms is positioned on a ground-facing side of the tracks and a second vertical end of at least one of the plurality of suspension arms is positioned on a non-ground facing side of the tracks. The robotic platform is configured to operate in a first orientation and a second orientation. In the first orientation a vertical vector of the robotic platform that is perpendicular to the longitudinal and lateral directions has a component parallel with and in the same direction as a gravity vector and in the second orientation the vertical vector has a component parallel with and in the opposite direction as the gravity vector.

Various embodiments of the various aspects may be implemented. In some embodiments, the plurality of rollers are configured to be tensioned on robotic platform h the ground-facing side of the tracks and the non-ground-facing side of the tracks.

In some embodiments, the groups of the plurality of rollers include pairs of rollers, each pair of rollers coupled to one of the plurality of suspension arms.

In some embodiments, each suspension arm is coupled to a shock absorber.

In some embodiments, each pair of rollers includes a first roller rotatably coupled to a first end of a curved connectors and a second roller rotatably coupled to a second end of the curved connector. The curved connector is moveably coupled to a suspension arm.

In some embodiments, each group of rollers is capable of independent movement.

In some embodiments, the robotic platform further includes a motor configured to operate the dual track dual suspension-tension system.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, may be arranged, substituted, combined, and designed in a wide variety of configurations, all of which are explicitly contemplated and made part of this disclosure.

FIG. 1 is a perspective view an embodiment of a robotic platform or “bot” having a dual track dual suspension-tension system;

FIG. 2 is a top perspective view of the robotic platform of FIG. 1;

FIG. 3 is a bottom perspective view of the robotic platform of FIG. 1;

FIG. 4 is a left side perspective view of the robotic platform of FIG. 1;

FIG. 5 is a right side perspective view of the robotic platform of FIG. 1;

FIG. 6A is a front view of the robotic platform of FIG. 1 in a first vertical orientation;

FIG. 6B is a front view of the robotic platform of FIG. 1 in a second vertical orientation opposite the first vertical orientation of FIG. 6A;

FIG. 7 is a rear view of the robotic platform of FIG. 1;

FIGS. 8A-8B are cross-sectional side views of the dual track dual suspension-tension system of FIG. 1 showing laterally left and right tracks extending over a plurality of rollers in various vertical positions;

FIG. 8C is a perspective view of two opposed assemblies of the plurality of rollers coupled to a central support;

FIG. 9A is a perspective view of a sensor assembly of the surveyor of FIG. 1 assembled with the robotic platform and also shown in exploded view for clarity;

FIG. 9B is a schematic showing an embodiment of a control system that may be used with the robotic platform of FIG. 1;

FIG. 10A is a perspective view of a gimbal mounted payload;

FIG. 10B is a top view of the robotic platform of FIG. 1, with the dual track dual suspension-tension system and the gimbal mounted payload of FIG. 10A removed, and the forward and rear bodies shown transparently, for illustrative purposes;

FIG. 11 is a perspective view of another example embodiment of a robotic platform having an excavation payload;

FIG. 12 is an example embodiment of a user control system for operating a robotic platform according to the present disclosure; and

FIGS. 13A-13D illustrate example embodiments of user interfaces for operating a robotic platform according to the present disclosure.

### DETAILED DESCRIPTION

The following detailed description is directed to certain specific embodiments of the robotic platform or “robots” or “bots”. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments. Reference will now be made in detail to embodiments of the invention, examples of which are illustrated in the accompanying drawings. Wherever possible, the same reference numbers will be used throughout the drawings to refer to the same or like parts.

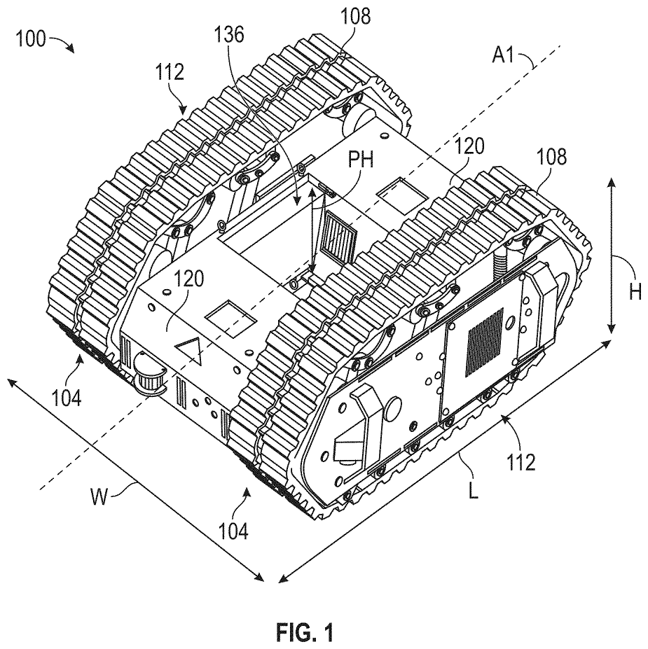

FIGS. 1-7 illustrate a robotic platform 100 in accordance with non-limiting embodiments of the present disclosure. The robotic platforms 100 can be used across various industries. Non-limiting examples include mining, construction, and infrastructure. Example mining applications include, pre- and post-blast mapping, topography surveying and analytics, detection of buried bodies, and rock properties assessments through the use of ground penetrating radar (GPR), Spectroscopy payloads, and/or magnetometers. The robotic platforms 100 can also be used in other environments, non-limiting examples include, search and rescue in extreme environments and surveying of hard to access areas, such as mountains, mud- or snow-covered regions, and regions where rockslides have occurred. The robotic platform 100 may be an autonomous, mobile machine intended to traverse and survey natural environments. The robotic platform 100 may be remotely monitored and/or controlled by a human operator or remote control system.

In some instances, the robotic platforms 100 can be used to survey, navigate, and/or map extreme environments on celestial bodies. During operation, the robotic platforms 100 may encounter extreme or uneven terrain that may cause the robotic platform to flip over. For example, the robotic platform 100 may navigate extremely rugged terrain, including high climbs, high descents and obstacles. In some instances, this extremely rugged terrain may cause the robotic platform to flip over. The potential flipping over of the robotic platform 100 may require the robotic platform to be functional when in a flipped or upright orientation. For example, the robotic platform 100 may need to have the ability to continue upside down to drive or move around the environment and/or capture or gather data using various sensors. In some embodiments, the robotic platform 100 may be vertically symmetric and thus a “right side up” orientation may not be substantively different from the “upside down” orientation, despite being intended to at least initially operate in a right side up orientation, as further described.

Embodiments of the present disclosure relate to robotic platforms 100 that may include dual inverted suspension systems capable of navigating extreme environments and continuing shock absorption if flipped over, robotic platforms that may include a gimbaled, symmetrically mounted and protected payload bay capable of rotating to account for the robotic platform flipping over and continuing payload operation when flipped over, and/or robotic platforms having symmetrically placed sensors to account for flipping that are capable of continuing operations based on inverted sensed data for mapping and/or navigation.

As shown in FIGS. 1-7, the robotic platform 100 may have a height H, width W, and length L. The height H may be between about 20 cm and about 300 cm, for example, about 20 cm, about 40 cm, about 60 cm, about 80 cm, about 100 cm, about 1200 cm, about 140 cm, about 160 cm, about 180 cm, about 200 cm, about 220 cm, about 240 cm, about 260 cm, about 280 cm, about 300 cm or any value in between. The length L may be between about 20 cm and about 300 cm, for example, about 20 cm, about 40 cm, about 60 cm, about 80 cm, about 100 cm, about 1200 cm, about 140 cm, about 160 cm, about 180 cm, about 200 cm, about 220 cm, about 240 cm, about 260 cm, about 280 cm, about 300 cm. The width W may be between about 20 cm and about 300 cm, for example, about 20 cm, about 40 cm, about 60 cm, about 80 cm, about 100 cm, about 1200 cm, about 140 cm, about 160 cm, about 180 cm, about 200 cm, about 220 cm, about 240 cm, about 260 cm, about 280 cm, about 300 cm.

The robotic platform 100 may have an operating speed of between about 0.05 m/s to about 5 m/s, for example, about 0.05 m/s, about 1.0 m/s, about 2.0 m/s, about 3.0 m/s, about 4.0 m/s, about 5.0 m/s, or any value in between. The robotic platform 100 may be capable of climbing or descending terrains of between 0 degree climb/descent to about 45 degree climb/descent, for example, about 0 degree, about 10 degree, about 20 degree, about 30 degree, about 40 degree, about 45 degree, or any value in between, where the angle is relative to a horizon. The robotic platform 100 may be able to climb obstacles having a height of between about 20 cm to about 60 cm, for example, about 20 cm, about 30 cm, about 40 cm, about 50 cm, about 60 cm, or any value in between.

### Example Dual Track Dual Suspension-Tension System

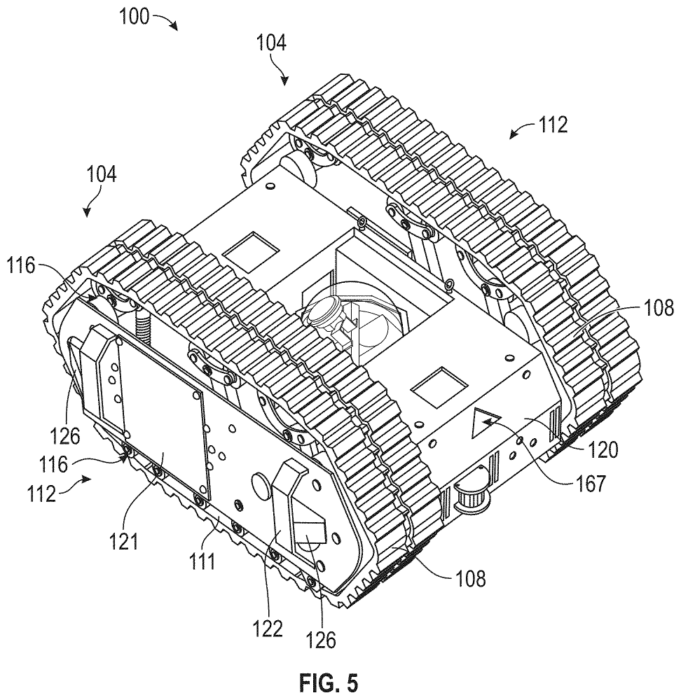

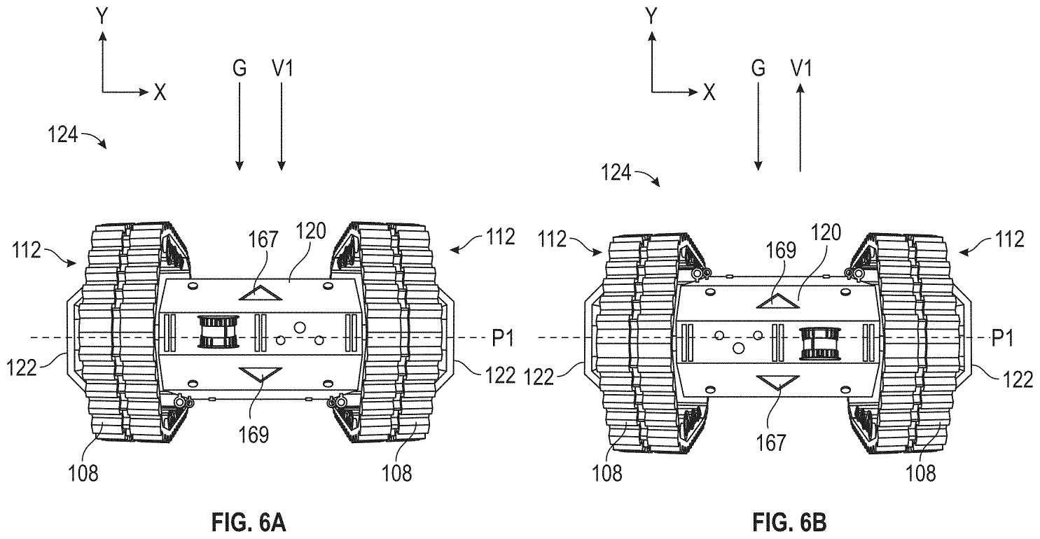

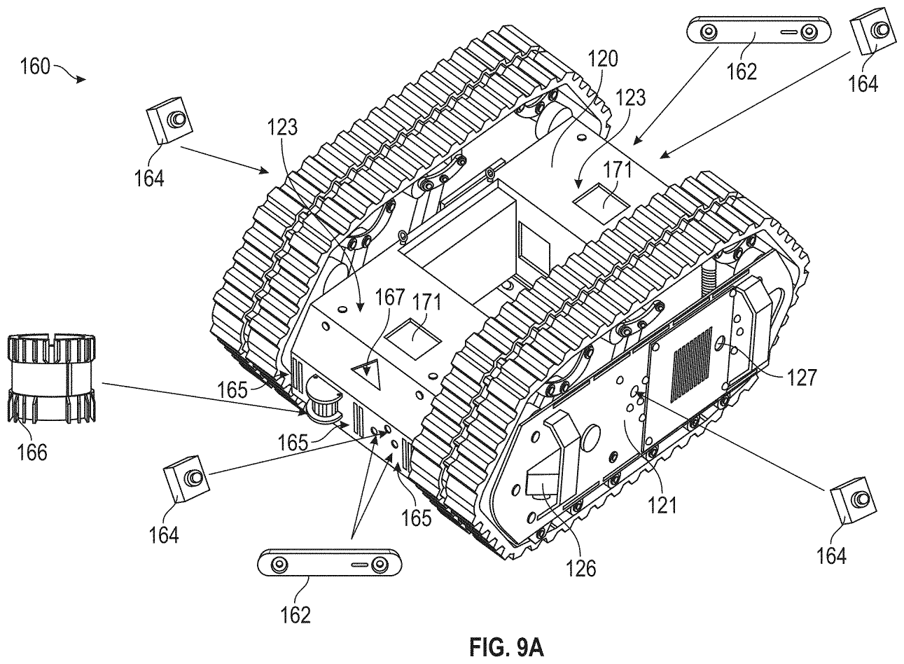

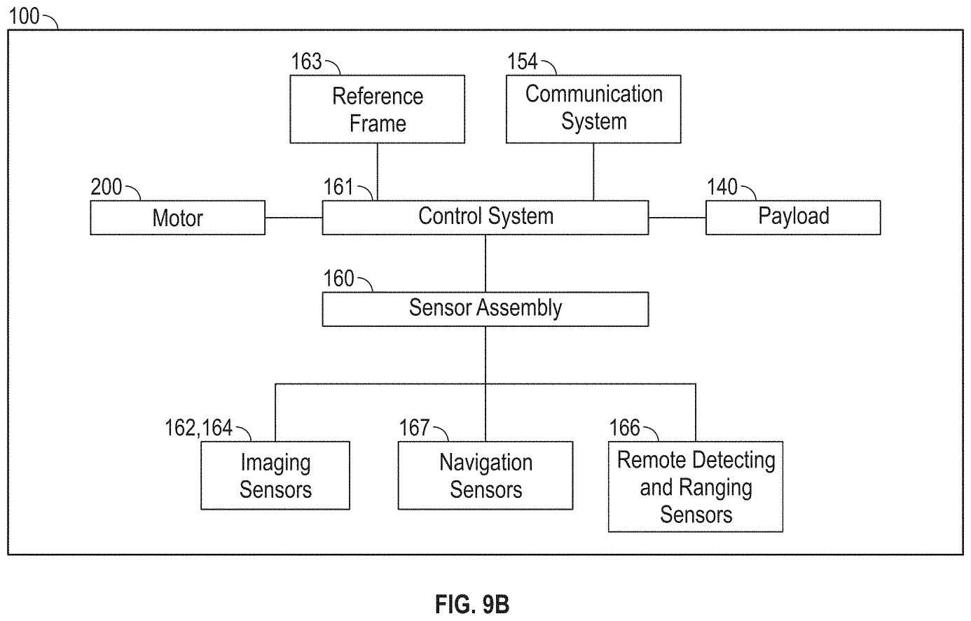

The robotic platform 100 may include a dual track dual suspension-tension system 104. In some embodiments, the dual track dual suspension-tension system 104 may include a plurality of tracks 108. Each track 108 may extend longitudinally in the direction of axis A1. Each track 108 may be positioned along a lateral side 112 of the robotic platform 100. The tracks 108 may be positioned over a plurality of rollers 116 (see, e.g., FIG. 4), discussed in more detail herein. The tracks 108 may have an uneven outer surface. The uneven outer surface may include a plurality of ridges 109 separated by a plurality of recesses 110, as labeled in FIGS. 8A and 8B. Each of the plurality of ridges 109 may have two angled side surfaces that are connected by a flat or planar top surface forming a generally trapezoidal shape. In some embodiments, the tracks 108 may have a generally smooth inner surface 111, for example as shown in FIGS. 4 and 5. In some embodiments, the tracks 108 may have an uneven inner surface 113 that generally mirrors the uneven outer surface, for example, as shown in FIGS. 8A and 8B. For example, the tracks 108 may have an uneven inner surface 113 that includes a plurality of ridges 114 separated by a plurality of recesses 115. Each of the plurality of ridges 114 may have two angled side surfaces that are connected by a flat or planar top surface forming a generally trapezoidal shape.

Each track 108 may be a continuous track running on a continuous band of rollers, or treads or track plates driven by one or more wheels. The large surface area of the tracks distributes the weight of the robotic platform 100, which may help to traverse soft ground with less likelihood of becoming stuck due to sinking. The tracks 108 may be made with soft belts of synthetic rubber reinforced with steel wires. The tracks 108 may be solid chain tracks made of steel plates (with or without rubber pads), also called a caterpillar tread or tank tread.

In some embodiments, the tracks 108 may have a track span distance T1, as labeled in FIG. 8A. The track span distance T1 may be the portion of the tracks 108 that contacts a flat ground surface as the robotic platform 100 navigates a flat surface. In some embodiments, the length L of the robotic platform 100 may exceed the track span distance T1. The portion of the tracks 108 along the track span distance T1 may not entirely contact the ground, e.g. where the ground is not flat. In some embodiments, the track span distance T1 may be between about 20 cm to about 300 cm, for example, about 20 cm, about 40 cm, about 60 cm, about 80 cm, about 100 cm, about 120 cm, about 140 cm, about 160 cm, about 180 cm, about 200 cm, about 220 cm, about 240 cm, about 260 cm, about 280 cm, about 300 cm, or any value in between.

The generally rugged nature of the tracks 108 may provide numerous advantages and benefits. For example, the rugged tracks 108 may allow for a low ground pressure and minimal terrain disruption or prevent or limit the chance that the robotic platform 100 buries in place. The rugged tracks 108 may allow for a consistent traction over the rough terrains due to the large contact area provided. Additionally, the rugged tracks 108 may perform better than wheeled or leg systems over similar terrain.

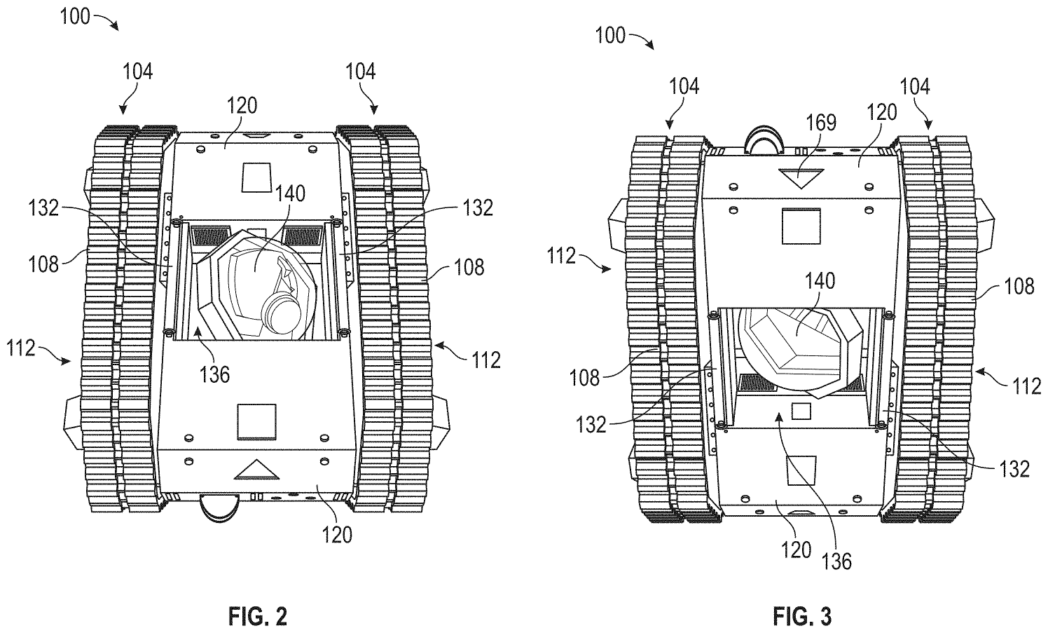

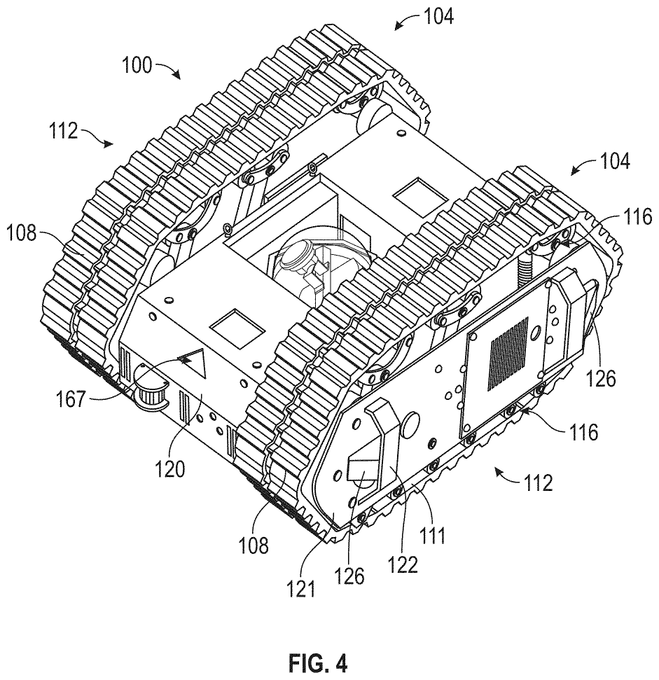

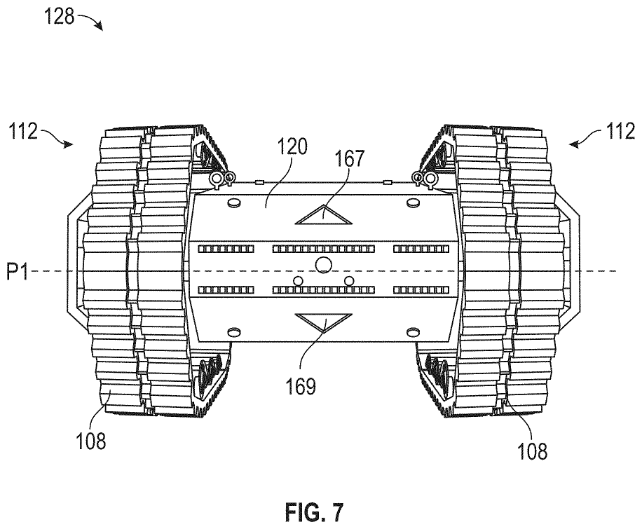

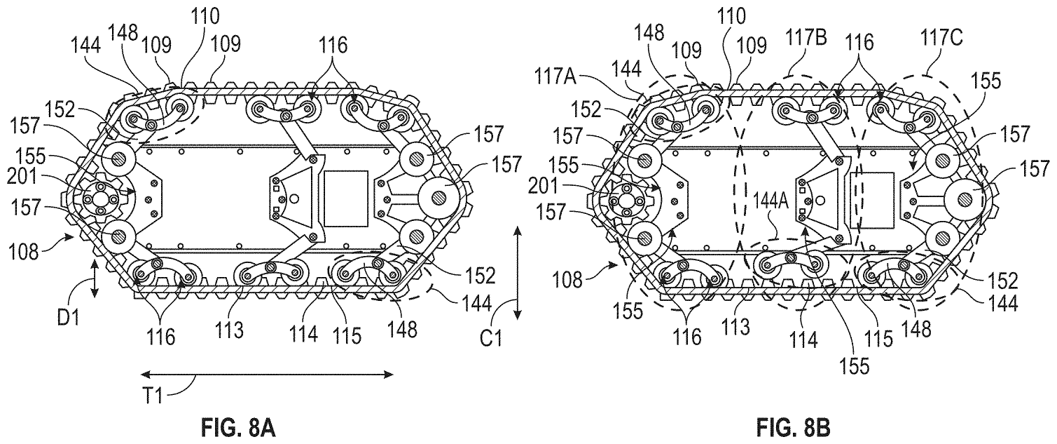

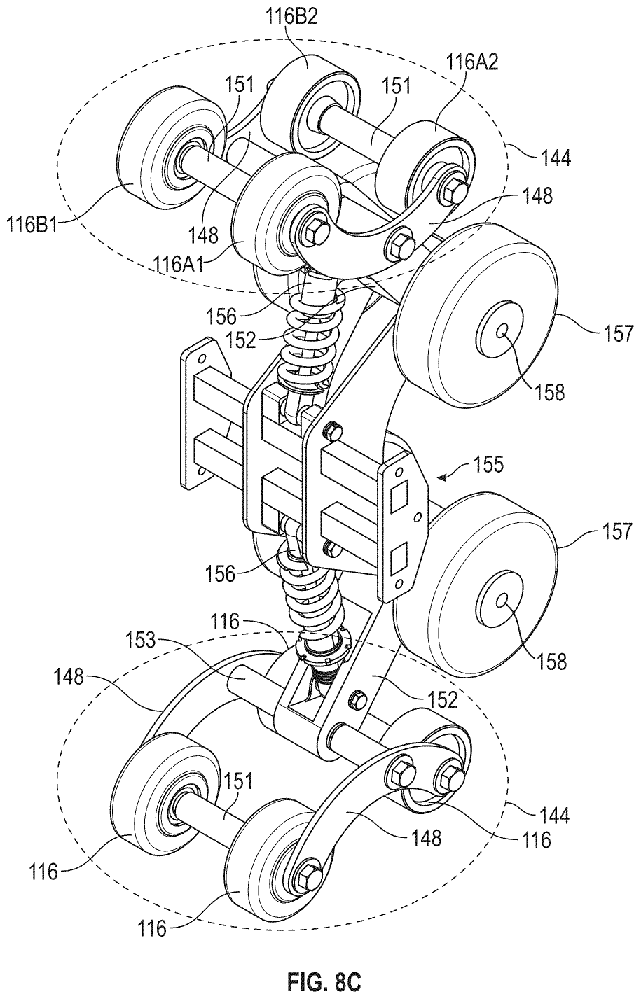

The robotic platform 100 may include a plurality of bodies 120 connecting the plurality of tracks 108. In some embodiments, a first body 120 can connect a first track 108 and a second track 108 at a forward end 124, as shown in FIGS. 6A and 6B, of the robotic platform 100 and a second body 120 can connect the first track 108 and the second track 108 at a rearward end 128, as shown in FIG. 7, of the robotic platform 100. The plurality of bodies 120 can extend generally perpendicular to the plurality of tracks 108. In some embodiments, the first and second bodies 120 can be connected by one or more walls 132 extending longitudinally along the tracks 108, for example, as shown in FIGS. 2 and 3. The bodies 120 may define compartments housing various electronics and sensors. In some embodiments, the bodies 120 may form an unitary structure. In some embodiments, the bodies 120 may be coupled together.

In some embodiments, the bodies 120 and the tracks 108 may define a payload bay 136. In some embodiments, the bodies 120 and the walls 132 may define the payload bay 136. The payload bay 136 may be protected on one or more sides by one or more of the bodies 120, tracks 108, and walls 132. The payload bay 136 may be accessible on one or more vertical sides. In some embodiments, the payload bay 136 may be accessible from a first direction above a horizontal plane P1 (labeled in FIGS. 6A-7) extending through the payload bay 136. In some embodiments, the payload bay 136 may be accessible from a second direction below the horizontal plane P1. The payload bay 136 being accessible from the second direction below the horizontal plane P1 may be beneficial in that it allows the payload 140 to have close proximity to the ground for sensing. In some embodiments, the payload bay 136 may be accessible from both above and below the horizontal plane P1. The payload bay 136 may be sized and shaped to receive a payload 140, as described in more detail herein. In some embodiments, the payload 140 or an additional payload(s) may be positioned inside one or both of the bodies 120 and/or positioned inside the tracks 108 or mounted above one or both of the bodies 120 and/or tracks 108.

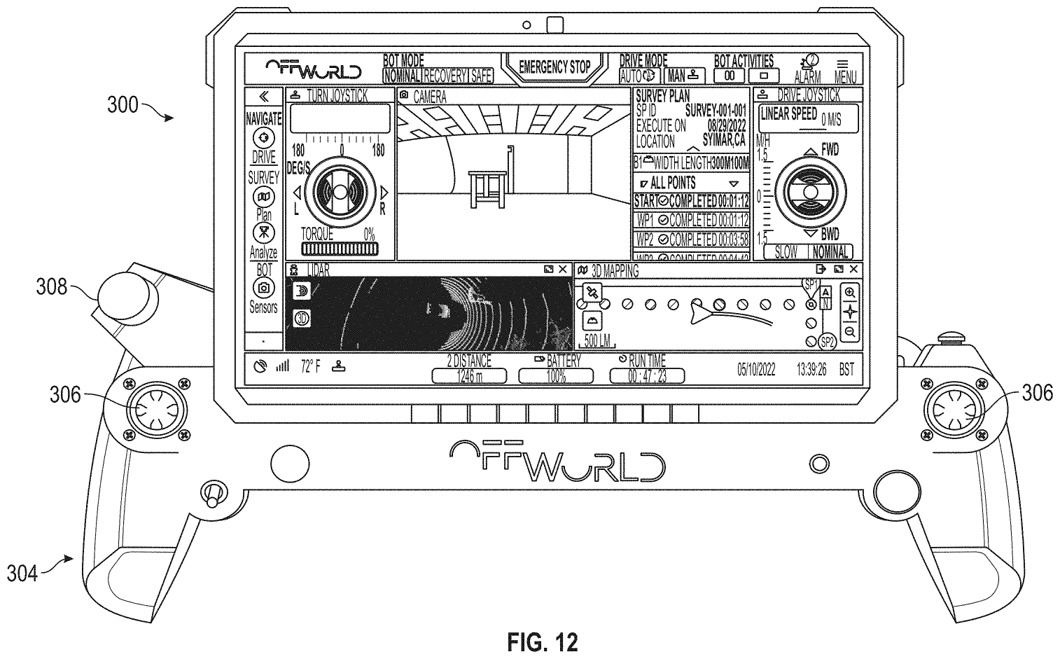

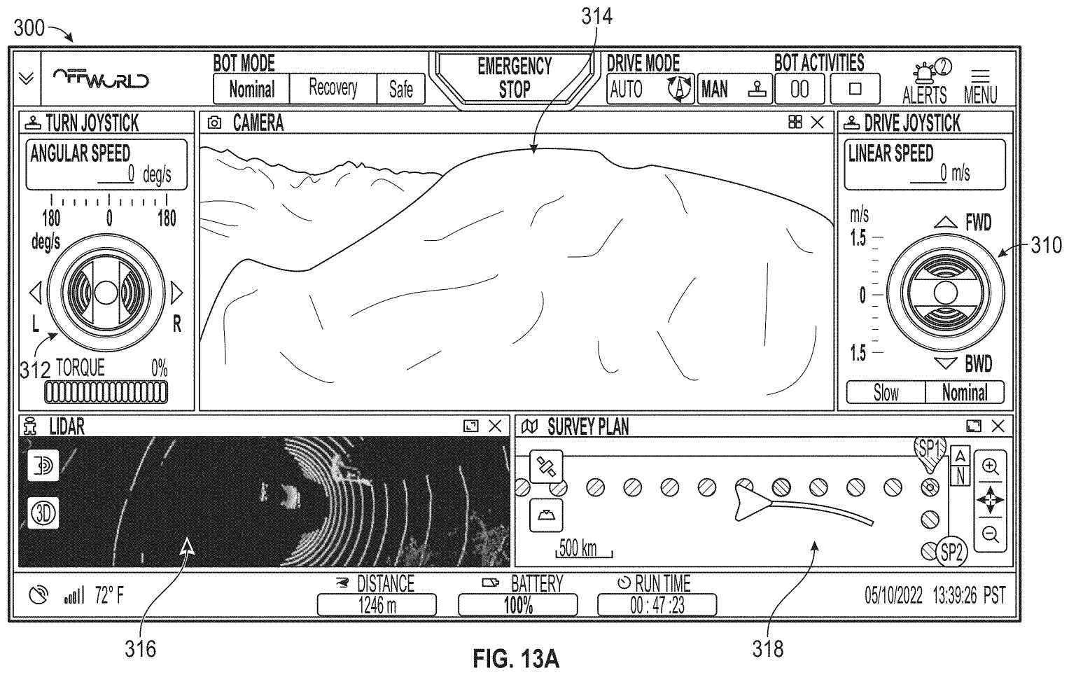

In some embodiments, the payload bay 136 may have a height PH, a width PW, and a length PL. The height PH (labeled in FIG. 1) may be between about 5 cm to about 200 cm, for example, about 5 cm, about 25 cm, about 50 cm, about 75 cm, about 100 cm, about 125 cm, about 150 cm, about 175 cm, about 200 cm or any value in between. The width PW (labeled in FIG. 10B) may be between about 5 cm to about 250 cm, for example, about 5 cm, about 25 cm, about 50 cm, about 75 cm, about 100 cm, about 125 cm, about 150 cm, about 175 cm, about 200 cm, about 225 cm, about 250 cm or any value in between. The length PL (labeled in FIG. 10B) may be between about 5 cm to about 250 cm, for example, about 5 cm, about 25 cm, about 50 cm, about 75 cm, about 100 cm, about 125 cm, about 150 cm, about 175 cm, about 200 cm, about 225 cm, about 250 cm or any value in between.

The payload bay 136 may define a payload ground clearance Cl, as labeled in FIG. 8A. The payload ground clearance Cl may be the distance from a lowest portion of a payload inside the payload bay 136 to a lowest portion of the bottom of the track 108. In some embodiments, the payload ground clearance Cl may be between about 14 cm and about 20 cm, for example about 14 cm, about 15 cm, about 16 cm, about 17 cm, about 18 cm, about 19 cm, about 20 cm, or any value in between. The payload ground clearance Cl can allow for the robotic platform 100 to navigate most terrains without causing damage to the payload.

FIGS. 8A and 8B are cross-sectional side views of the robotic platform 100 showing one of the tracks 108 positioned over the plurality of rollers 116. In some embodiments, the rollers 116 may be wheels. The plurality of rollers 116 can be positioned on both ground facing and non-ground facing sides of the robotic platform 100. The plurality of rollers 116 may be assembled into one or more roller assemblies 117A, 117B, 117C. In some embodiments, the plurality of rollers 116 may be assembled into three roller assemblies 117A, 117B, 117C, as labeled in FIG. 8B. The laterally opposite track 108 of FIG. 8A may likewise include such assemblies of the rollers 116.

In some embodiments, each roller assembly 117A, 117B, 117C may include groups 144 of the rollers 116 (e.g. see FIG. 8C). In some embodiments, each group 144 of rollers 116 may be capable of movement independent of other groups 144 of rollers 116. For example, as shown in FIG. 8A all groups 144 of rollers 116 are in contact with a portion of the track 108, while in FIG. 8B one of the groups 144A of rollers 116 has moved vertically upward, e.g. in response to traversing rocks or other protrusions on the ground. The group 144A of rollers 116 is shown no longer in contact with the track 108 for clarity. If traversing a rock or other vertical projection in that area, the track 108 may likewise move upward with the group 144A of rollers 116.

FIG. 8C illustrates the roller assembly 117A. While the roller assembly 117A is depicted, the features described herein may apply to roller assemblies 117B, 117C where appropriate. In some embodiments, each group 144 of rollers may include a plurality of the rollers 116. In some embodiments, each group 144 may include four rollers 116. Each group 144 may include a first pair of rollers 116A including a first roller 116A rotatably coupled to a first end of a connector 148 and a second, opposite roller 116A rotatably coupled to a second, opposite end of the connector 148. In some embodiments, each group of rollers may include a second pair of rollers 116B, including a third roller 116B rotatably coupled to a first end of a second connector 148 and a fourth roller 116B rotatably coupled to a second, longitudinally opposite end of the second connector 148. In some embodiments, the connectors 148 may be curved. In some embodiments, the connectors 148 may be longitudinal connectors. The first pair of rollers 116A and the second pair of rollers 116B may be coupled together. For example, the first roller 116A from the first pair of rollers 116A may be coupled to the third roller 116B from the second pair of rollers 116B and the second roller 116A from the first pair of rollers 116A may be coupled to fourth roller 116B from the second pair of rollers 116B. The pairs of rollers 116A, 116B may be coupled via one or more respective axles 151, such as rods or pins. The axles 151 may extend laterally. In some embodiments, each pair of rollers 116A, 116B, may have two different sized rollers. For example, a first roller 116A1, 116B1 from the pair of rollers 116A, 116B may have a larger diameter and/or width than a second roller 116A2, 116B2 from the pair of rollers 116A, 116B. For example, rollers 116A1, 116B1 are larger than rollers 116A2, 116B2, as shown in FIG. 8C. The larger rollers may be positioned forward or aft of the smaller rollers when assembled with the platform.

The connector 148 of each pair of rollers 116A, 116B may be moveably coupled to a suspension arm 152. A shaft 153 may extend laterally from the first connector 148 through an opening in an end of the suspension arm 152 to the second connector 148. The shaft 153 may allow the group 144 of rollers 116 to rotate relative to the suspension arm 152. The connector 148 may rotate about the shaft 153 thereby rotating the rollers 116 about the shaft 153 as well. The shaft 153 may extend along an axis parallel to a lateral direction of the robotic platform. Both upper and lower groups 144 of rollers 116 (as oriented in the figure) may include the shaft 153 as described.

The suspension arms 152 may rotatably couple the groups 144 of rollers 116 to a support 155. In some embodiments, each suspension arm 152 may be coupled to a shock absorber 156. The shock absorber 156 may be a pneumatic and/or spring-loaded device. The suspension arm 152 may rotate about a lateral axis extending through the rollers 157. An axle 158, such as a shaft or pin, extending between laterally opposite pairs of rollers 157 may rotatably connect inward ends of the suspension arm 152 to an outward end of the support 155. Each suspension arm 152 may be rotatably biased outwardly by the respective shock absorber 156. The shock absorber 156 may be rotatably coupled to a central portion of the support 155. The shock absorber 156 attenuates forces applied to the rollers 116 and retracts linearly in response. One or more groups 144 of rollers 116 may be coupled to a single support 155.

In some embodiments, supports 155 coupled to groups 144 of rollers 116 near the forward end or rearward end of the robotic platform 100 may include one or more additional rollers 157 configured to be positioned between the ground facing side and the non-ground facing side of the tracks 108 (e.g., along the height of the robotic platform 100). The additional rollers 157 can help guide the tracks during operation of the robotic platform 100.

Similar arrangements of rollers as described with respect to FIG. 8C may be used for one or more of the roller assemblies 117A, 117B, 117C. For example, the groups 144 of rollers 116 in each assembly 117A, 117B, 117C may rotate and/or actuate inward and outward as described to compensate for changes in elevation of the topography traversed by the robotic platform 100. Thus, similar arrangements of the rollers 116 on a rotating suspensions arm 152 biased by a shock absorber 156, etc. as described, may be included. Further, with reference to roller assembly 117A, two groups 144 of rollers 116 may be coupled to the support 155 and two additional rollers 157 may be coupled to the support 155. The two additional rollers 157 may be positioned between the two groups 144 of rollers 116. The two additional rollers 157 may be spaced such that a motor output wheel (e.g., motor output wheel 201 described herein) may be positioned between the two additional rollers 157. The two additional rollers 157 may be positioned more forward than the two groups 144 of rollers 116. The motor output wheel 201 may be positioned more forward than the two additional rollers 157. The motor output wheel may form an apex at the forward end 124 of the robotic platform 100.

With reference to roller assembly 117B, two groups 144 of rollers 116 may be coupled to the support 155. The roller assembly 117B may include no additional rollers 157 as the roller assembly 117B may only be in contact with the ground facing and non-ground facing sides of the tracks 108 (e.g., not in contact with forward and aft portions of the tracks 108, extending up the height H of the robotic platform 100).

With reference to roller assembly 117C, two groups 144 of rollers 116 may be coupled to the support 155 and three additional rollers 157 may be coupled to the support 155. The three additional rollers 157 may be positioned between the two groups 144 of rollers 116. The three additional rollers 157 may be positioned more rearward than the two groups 144 of rollers 116. A centrally positioned additional roller 157 of the three additional rollers 157 may be positioned more rearward than the two additional rollers. The centrally positioned additional roller 157 may form an apex at the rearward end 128 of the robotic platform 100.

During operation of the robotic platform 100, the plurality of rollers 116 on the non-ground facing side (e.g. upward as oriented in the figures) of the robotic platform 100 may apply tension to the tracks 108. For example, as shown in FIGS. 8A and 8B, the suspension arms 152 may be biased by the shock absorber 156 to push the groups 144 of rollers 116 toward the non-ground facing side of the tracks 108 applying a tension or force.

During operation of the robotic platform 100, the plurality of rollers 116 on the ground facing side of the robotic platform 100 may dampen out forces from harsh terrain to protect the robotic platform 100 and facilitate navigation sensor data collection and processing. For example, the plurality of rollers 116 on the ground facing side may minimize any jittering or unintended shocks to the sensors caused by the terrain being navigated. The suspension arms 152 and/or shock absorbers 156 can assist in allowing the groups 144 of rollers 116 to move in the vertical direction as needed to absorb any unintended motion. For example, as shown in FIG. 8A, the ground facing plurality of rollers 116 (along the length T1) are positioned closer to the supports 155 as compared to the non-ground facing plurality of rollers 116. The angled positioning of the suspension arms 152 of the ground facing plurality of rollers 116 may also be different than the angled positioning of the suspension arms 152 of the non-ground facing plurality of rollers 116.

In some embodiments, the robotic platform 100 may have a suspension travel distance D1, as labeled in FIG. 8A. The suspension travel distance D1 may be a maximum distance inwardly that the rollers 116 may move, which movement may be upward for ground-facing rollers 116 when traversing ground. The non-ground facing rollers 116 may likewise move downward for a suspension travel distance D1. In some embodiments, the suspension travel distance D1 may be between about 0 cm to about 25 cm, for example, about 0 cm, about 5 cm, about 10 cm, about 15 cm, about 20 cm, about 25 cm, or any value in between. The suspension travel distance D1 may decrease wear and tear from shocks and/or vibrations and may allow the tracks 108 to conform to the terrain allowing for increased traction and faster motion.

As described herein, the robotic platform 100 is capable of continuing to operate in the event that the surveyor changes orientation (e.g., flips over). In some instances, the robotic platform 100 may encounter a high ledge and/or obstacle (e.g., a boulder) that may cause the robotic platform 100 to switch to an inverted orientation. For example, the robotic platform 100 according to the present disclosure may start operating a first orientation, for example as shown in FIG. 6A. As the robotic platform navigates terrain some obstacle (e.g., a steep hill) may cause the robotic platform 100 to transition to a second orientation (e.g., flip over), for example as shown in FIG. 6B. The robotic platform 100 may then continue to operate even though it is in a different orientation than the robotic platform 100 was originally operating in.

In the first orientation shown in FIG. 6A, the robotic platform 100 may define a vertical vector V1 that is perpendicular to the longitudinal and lateral directions and may have a vertical component parallel with and in the same direction as a gravity vector G1. In the second orientation shown in FIG. 6B, the vertical vector V1 may have a vertical component parallel with and in the opposite direction as the gravity vector G1. When the robotic platform 100 is perfectly horizontal as shown, the entire vector V1 is in the vertical direction, such that there is only a vertical component and no horizontal components. If the robotic platform 100 is not perfectly horizontal, then the vector V1 would have a vertical component and one or more horizontal components.

In the event that the robotic platform 100 switches from the first orientation to the second orientation, the tensioning and the shock absorption as described with reference to FIGS. 8A-8C may switch. For example, each side of the tracks 108 may be capable of operating as a ground facing side and a non-ground facing side 108. Thus, each side of the tracks 108 is capable of applying tension to the tracks 108 and absorbing shocks produced while navigating terrain. The track and system is thus a dual orientation system.

In the event that the robotic platform 100 lands on one of its lateral sides, the robotic platform 100 includes features to facilitate rolling back onto the tracks 108. In some embodiments, the robotic platform 100 may include outer side walls 121 (see FIGS. 4-6B) positioned within an area defined by each track 108. The outer side walls 121 may include one or more roll over bars 122 disposed on the outer side walls 121, for example as shown in FIGS. 4 and 5. The one or more roll over bars 122 can extend longitudinally some distance laterally outwardly from the outer side wall 121. The one or more roll over bars 122 can assist the robotic platform 100 in returning to the first or second orientation in the even the robotic platform 100 tilts or lands on either lateral side.

### Example Sensor Assembly

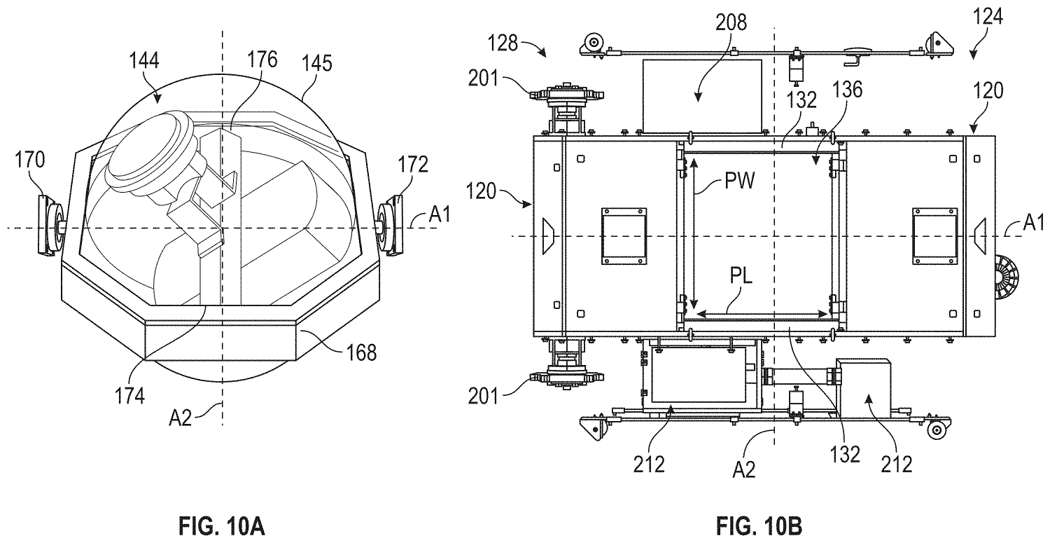

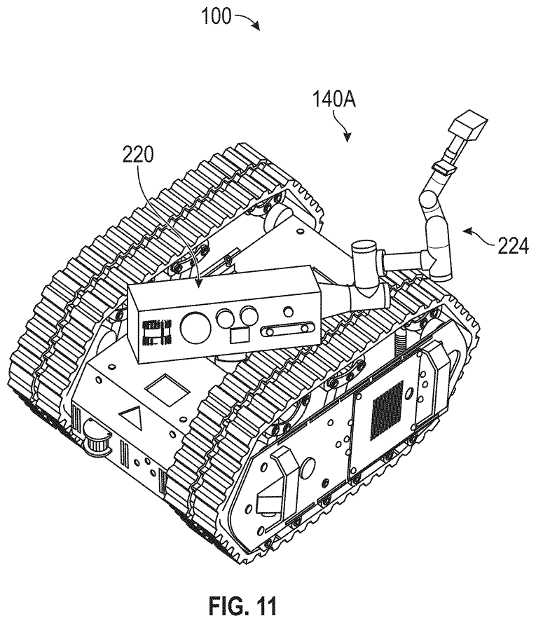

As shown in FIG. 9A, in some embodiments, the robotic platform 100 may include a sensor assembly 160. The sensor assembly 160 is shown with sensors embedded in the robotic platform 100 as well as those same sensors shown in isolation outside the robotic platform 100 for clarity.

The sensor assembly 160 may include a plurality of sensors. The plurality of sensors can include one or more first imaging sensors 162 such as stereo cameras, one or more second imaging sensors 164 such as fisheye cameras, and/or one or more remote detection and ranging sensors 166 such as 3D light detecting and ranging (LiDAR) sensors. Two or more of the plurality of sensors may be symmetrically positioned about the robotic platform 100 relative to the horizontal plane P1. Two or more of the plurality of sensors may be symmetrically positioned about the robotic platform 100 about the axis A1. One or more of the plurality of sensors may be mounted to and/or disposed within the one or more bodies 120 and be accessible by one or more moveable access panels 123. In some embodiments, the sensor assembly 160 can include one or more lights 165 such as LED headlights. The one or more headlights 165 may be positioned within one or both of the bodies 120. The body 120 may protect the one or more lights 165 from impacts and ingress of debris such as dust and water.

In some embodiments, the sensor assembly 160 may include a third imaging sensor 167 such as a camera or navigation camera, and which may be used for navigational purposes, as shown in FIGS. 4-6B. The third imaging sensor 167 may be disposed within one or both of the bodies 120. In some embodiments, the third imaging sensor 167 may be positioned on or in the forward end of the forward body 120 and/or in the aft end of the aft body 120. The third imaging sensors 167 may be disposed on an upper region of the body when the vehicle is in a first vertical orientation. In some embodiments, the sensor assembly 160 may include a fourth imaging sensor 169 (see FIGS. 3, 6A and 6B), such as a camera or navigation camera, and which may be used for navigation. The fourth imaging sensor 169 may be the same type of sensor as the third imaging sensor 167. The fourth imaging sensor 169 may be a low-to-ground sensor, such as a navigation camera. The fourth imaging sensor 169 may be disposed within or on one or both of the forward and aft bodies 120. In some embodiments, the fourth imaging sensor 167 may be positioned on or in the forward end of the forward body 120 and/or in the aft end of the aft body 120. The third imaging sensors 167 may be disposed on an upper region of the body when the vehicle is in a first vertical orientation, and the fourth imaging sensors 169 may be disposed on an opposite, lower region of the body when the vehicle is in a second vertical orientation opposite the first orientation.

In some embodiments, the sensor assembly 160 may include the one or more second imaging sensors 164 positioned on each outer sidewall 121. In some embodiments, a first of the one or more second imaging sensors 164 may be positioned on or in a first lateral outer sidewall 121 and a second of the one or more second imaging sensors 164 may be positioned on or in a second lateral outer sidewall 121, the second lateral sidewall 121 opposite the first lateral outer sidewall 121. In some embodiments, the sensor assembly 160 may include one or more second imaging sensors 164 positioned on each body 120. In some embodiments, a first of the one or more second imaging sensors 164 may be positioned on or in the forward end of the forward body 120 and a second of the one or more second imaging sensors 164 may be positioned on or in an aft end of the aft body 120.

In some embodiments, the sensor assembly 160 may include the one or more first imaging sensors 162 positioned on each body 120. In some embodiments, a first of the one or more first imaging sensors 162 may be positioned on or in the forward end of the forward body 120 and a second of the one or more first imaging sensors 162 may be positioned on or in an aft end of the aft body 120. In some embodiments, the sensor assembly may include one or more remote detection and ranging sensors 166 positioned on at least one of the bodies 120. In some embodiments, the one or more remote detection and ranging sensors 166 may be positioned on or in the forward end of the forward body 120. In some embodiments, the one or more remote detection and ranging sensors 166 may be positioned on or in the aft end of the aft body 120. In some embodiments, one or more remote detection and ranging sensors 166 may be positioned on each body 120. In some embodiments, a first of the one or more remote detection and ranging sensors 166 may be positioned on or in the forward end of the forward body 120 and a second of the one or more remote detection and ranging sensors 166 may be positioned on or in an aft end of the aft body 120. In some embodiments, the one or more remote detection and ranging sensors 166 may be mounted on a tilting platform on the body 120. In some embodiments, the one or more remote detection and ranging sensors 166 may include a protective cage. In some embodiments, one or more imaging sensors may be positioned on a ground facing surface and/or non-ground facing surface of one or both bodies 120. In some embodiments, one or more imaging sensors may be positioned such that the one or more imaging sensors is capable of viewing the payload bay 136.

In some embodiments, the sensor assembly 160 may include one or more antennas 171, such as a global positioning system (GPS) antenna and/or a global navigation satellite system (GNSS) antenna. In some embodiments, the sensor assembly 160 may include at least four antennas 171, where at least one antenna 171 is positioned on a non-ground facing surface of each body 120 (e.g., the forward body and the aft body) and at least one antenna 171 is positioned on a ground facing surface of each body 120 (e.g., the forward body and the aft body). The positioning on each side of each body 120 allows for coverage in the event the robotic platform 100 flips over.

In some embodiments, the outer side walls 121 may include one or more antennas 126, such as Wi-Fi antennas. The one or more antennas 126 may be positioned on each outer side wall 121 to provide for 360 degree coverage. There may be a first antenna 126 at a forward end of a first side wall 121, a second antenna 126 at an aft end of the first side wall 121, a third antenna at a forward end of a second opposite side wall 121, and a fourth antenna 126 at an aft end of the second side wall 121. In some embodiments, one or both of the outer side walls 121 may include an emergency stop button 127. The emergency stop button 127 can be easy to access while also being protected by a shroud. In some embodiments, the outer sidewalls 121 may include LED warning lights. The LED warning lights may be color coded to provide robotic platform 100 information, such as a warning or status information.

FIG. 9B is a schematic of the robotic platform 100 showing an embodiment of a control system 161. The control system 161 may include one or more processors and one or more memory modules therein. The processor of the control system 161 may be configured to execute instructions stored in the memory modules to perform the various methods described herein. The control system 161 may be configured to receive and analyze data from the sensor assembly 160 including the various sensors 162, 164, 166, 167. The control system 161 may be configured to analyze data and communicate information related thereto via a communication system 154, such as an antenna, transceiver, etc. The control system 161 may operate the motor 200 and/or payload 140 to control movement of the robotic platform 100 and actions of the payload 140 respectively, based on data detected by the sensor assembly 160 and/or received via the communication system 154.

As further shown in FIG. 9B, the sensor assembly 160 may operate according to a reference frame 163. In some embodiments, the reference frame may be controlled by the control system 161. In the event that the robotic platform 100 transitions between the first vertical orientation and the second, opposite vertical orientation, as described herein, the control system 161 may invert the reference frame 163. The inversion of the reference frame 163 may allow the sensor assembly 160 of the robotic platform 100 to continue to operate in either orientation. The control system 161 may communicate data related to the reference frame 163 and sensor orientation with a user or remote receiver via the communication system 154. For example, as described herein, FIG. 6A shows the robotic platform 100 in a first orientation and FIG. 6B shows the robotic platform 100 in a second orientation, representing a flipped robotic platform 100. As illustrated in FIG. 6B, the reference frame 163 relative to the orientation of the robotic platform 100 has been inverted. For example, the robotic platform 100 may continue to operate along the same X and Y directions in either orientation but the reference frame 163 of the sensor assembly 160 has been inverted via the software of the control system 161, such as the processor executing instructions of the memory modules in the control system 161, to allow the robotic platform 100 and the plurality of sensors to continue to operate as intended.

The sensor assembly 160 may be used for real time mapping of a surrounding 3D environment. The real time mapping may include 3D scanning from the one or more remote detection and ranging sensors and one or more first imaging sensors 162, color mapping of the environment, filtering and down sampling of the point cloud (e.g., a collection of individual points plotted in space that may represent a 3D shape or object), merging of the point cloud with a generated map using robotic platform localization, and/or live visualization of the map by an operator through a user interface to help navigate the environment. Additionally, the sensor assembly 160 may assist in motion planning and collision avoidance, as well as for providing full situational awareness to operators.

### Example Mounted Payload

FIG. 10A shows an example payload 144, shown in isolation from the robotic platform 100 for clarity. In some embodiments, the payload 144 may be a LiDAR sensor. The payload 144 may be mounted within the payload bay 136. The payload 144 may be protected by the payload bay 136 as described herein. In some embodiments, the payload 144 may include a protective cover 145. In some embodiments, the protective cover 145 may be a transparent material. In some embodiments, the payload 144 may be mounted using a gimbaled mount 168. The gimbaled mount 168 may allow the payload 144 to rotate about one or more axes.

The payload 144 may be actively or passively rotated. The payload 144 may freely rotate in response to changes in orientation of the robotic platform 100. As the robotic platform 100 traverses inclines, declines, and/or lateral slopes, the payload 144 may passively rotate accordingly to maintain pointing of the sensors in alignment with or substantially in alignment with a desired direction, such as the gravity vector. The rotational connections of the gimbaled mount 168 may allow for such rotations. The payload 144 may rotate to invert vertically 180 degrees if the robotic platform 100 flips over. In some embodiments, the payload 144 may be actively rotated via a motor or other actuator. The rotational connections of the gimballed mount may be controlled via one or more actuators that cause rotation of the respective connection. The control system 161 may detect the orientation of the vehicle and rotationally control the connections accordingly to maintain a desired orientation of the payload 144 relative to the gravity vector. The active rotation may be performed autonomously by the control system 161, or remotely via operator input.

The gimbaled mount 168 may be mounted at a first rotational mount 170 to a first of the bodies 120 (e.g. the forward body) and at a second rotational mount 172 to a second of the bodies 120 (e.g. the aft body). The first rotational mount 170 and the second rotational mount 172 may be positioned on opposite longitudinal sides of the payload 144. The first rotational mount 170 and the second rotational mount 172 may allow the gimbaled mount 168 to rotate about the longitudinal axis A1 of the robotic platform 100.

In some embodiments, the first rotational mount 170 may be mounted to a first wall 132 on a first lateral side of the robotic platform 100, and the second rotational mount 172 may be mounted to a second, opposite wall 132 on a second lateral side of the robotic platform 100. The mounting of the rotational mounts 170, 172 to the walls 132 may allow the gimbaled mount 168 to rotate about a lateral axis A2 that is generally perpendicular to the longitudinal axis A1.

The payload 144 may be rotatable about two axes. In some embodiments, the payload 144 may be coupled to the gimbaled mount 168 at a first internal rotational connection 174 and a second internal rotational connection 176 which are offset from the first and second rotational mounts 170, 172. The first rotational connection 174 and the second rotational connection 176 may be positioned on opposite lateral sides of the payload 144. The first rotational connection 174 and the second rotational connection 176 may allow the payload 144 to rotate about the lateral axis A2 in instances where the first and second rotational mounts 170, 172 are coupled to the bodies 120. In instances where the first and second rotational mounts 170, 172 are coupled to the walls 132, the rotational connections 174, 176 may allow the payload 144 to rotate about the longitudinal axis A1. The gimbaled mount 168 and the payload 144 may thus rotate about different axes. The rotation of the payload 144 about the internal rotational connections 174, 176 may be passive or active, as described above with respect to the external rotational mounts 170, 172.

As described herein, the robotic platform 100 is capable of continuing to operate in the event that the robotic platform 100 transitions from the first vertical orientation to the second, opposite vertical orientation. In the event that the robotic platform 100 does transition between such orientations, the gimbaled payload 144 is capable of rotating as needed to account for the change in orientation. For example, the gimbaled payload 144 may automatically (passively or actively) rotate so that the line of sight or detection of any sensors therein remain aligned along the gravity vector G1.

### Example Component Bay

As shown in FIG. 10B, in some embodiments, the robotic platform 100 may include components disposed within and/or mounted to the bodies 120 and/or walls 132. The robotic platform 100 may include one or more motors 200. The one or more motors 200 may be disposed within one of the bodies 120. The one or more motors 200 may be configured to operate the dual track dual suspension-tension system 104. Each of the one or more motors 200 may cause a motor output wheel 201 to rotate, as labeled in FIGS. 8A, 8B, and 10B. The one or more motor output wheels 201 may comprise ridges and recesses that are configured to engage the ridges 114 and recesses 115 of the inner surface 113 of the track 108. The motor 200 may cause the motor output wheel 201 to rotate which may cause the robotic platform 100 to move across a surface.

In some embodiments, the robotic platform 100 may include a control system 161. The control system 161 may be in communication with and configured to receive data from the one or more computers 208. The control system 161 may be disposed within one of the bodies 120. Additional components that may disposed within one of the bodies 120 include fuse and relay boxes, global navigation satellite system (GNSS) antennas, and/or cooling fans. In some embodiments, the one or more motors 200, the control system 204, and/or the fuse and relay boxes, global navigation satellite system (GNSS) antennas, and cooling fans may be disposed in the rearward end 128 of the robotic platform 100.

In some embodiments, the robotic platform 100 may include one or more computers in an ingress protected box 208. The one or more computers 208 may include an air cooling system. The one or more computers 208 may be mounted to one of the walls 132. In some embodiments, the one or more computers 208 may be mounted to a payload bay facing surface of one or more of the walls 132. The one or more computers 208 may be configured to function with Wi-Fi antennas and/or the sensor assembly 160.

In some embodiments, the robotic platform 100 may include power electronics in an ingress protected box 212. The ingress protected box 212 may be mounted to one of the walls 132 and/or outer side walls 121. In some embodiments the ingress protected box 212 may be mounted between one of the walls 132 and one of the outer side walls 121. In some embodiments, the walls 132 and/or the outer side walls 121 may be panels. The panels may be removable to allow access to an area within the walls 132 and/or outer side walls 121. The power electronics may be configured to function with Wi-Fi antennas and/or fisheye cameras mounted to the same wall 132.

In some embodiments, the robotic platform 100 may include one or more batteries (not shown). The battery may be disposed within one of the bodies 120. In some embodiments, the battery may be disposed within the forward end 124 of the robotic platform 100. The battery may be rechargeable and/or removable from the robotic platform 100. The battery may be configured to power the robotic platform 100. The robotic platform 100 may therefore have an electric motor. In some embodiments, the robotic platform 100 may have other motors, such as internal combustion or hybrid engines.

### Example Robotic Platform Applications

As described herein the robotic platform 100 may be used in various environments for various purposes. Non-limiting examples include autonomous mapping, blast movement monitoring, excavation surveying, and patrolling.

When used for autonomous mapping purposes, the robotic platform 100 may have autonomous driving capabilities based, at least in part, on GPS-defined survey points and boundaries. The robotic platform may use the sensor assembly 160 for live mapping of the environment and terrain. The robotic platform 100 may use the sensor assembly to assist in avoiding obstacles and slopes that would prevent the robotic platform 100 from navigating the terrain. The robotic platform 100 may use the dual track dual suspension-tension system 104 to navigate rocky or uneven terrain.

The autonomous mapping features of the robotic platform 100 may be using in mining and exploration missions. For example, the robotic platform 100 may be used for post blast inspections, ore pass condition assessments, visual assessments of geological conditions (e.g., rock stability and faults), remote inspections, generating 3D models of mines, and/or green field/brown filed mapping. The autonomous mapping features may also be used in other industries, for example, construction. The autonomous mapping may be used for 3D modeling and mapping and for site progress inspections.

When used for blast movement monitoring (BMM) purposes, the robotic platform 100 may include the payload 140 having a detector configured to measure power transmitted by BMM spheres that have been buried in multiple locations before a blast. After a blast, the BMM spheres may move locations and the payload 140 may be used to identify the new positioning of the BMM spheres by triangulating the positioning by measuring the power being transmitted. The difference in positioning from before and after the blast may be used to help measure the displacement of rock during the blast.

When used for patrolling purposes, the robotic platform 100 may autonomously patrol hard-to-navigate areas. In some instances, the robotic platform 100, may be used to patrol areas to protect endangered species from poachers. The robotic platform 100 may be used to patrol areas during any time of day and be configured with nighttime vision cameras, long range communication, high speed drivetrain, and/or microphones and speakers. Data collected by the robotic platform 100 may than be forwarded to a remote control center for review.

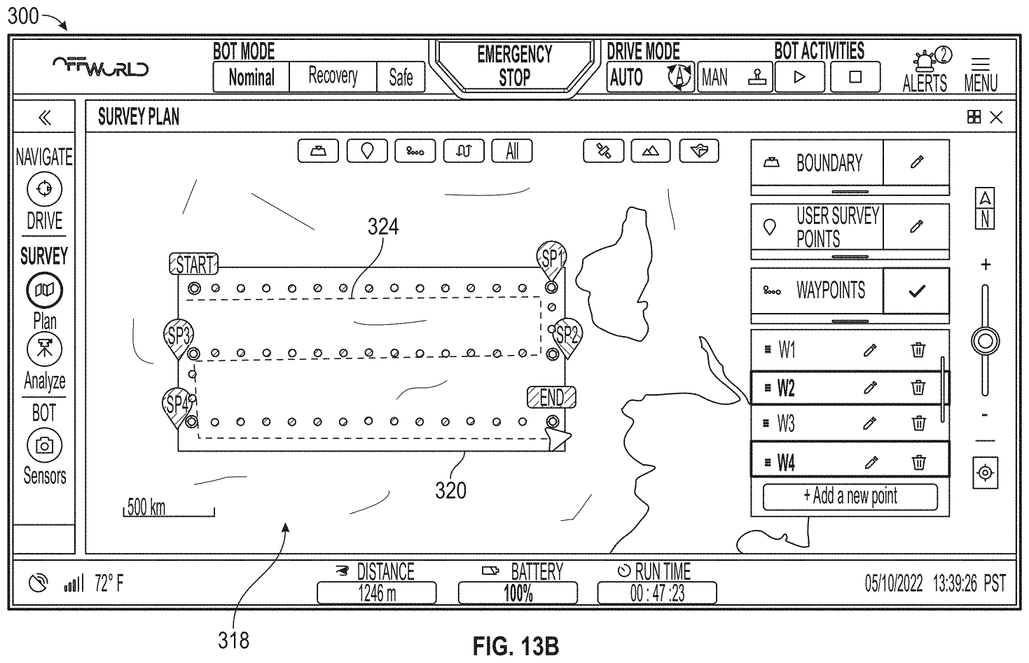

FIG. 11 depicts an embodiment of the robotic platform 100 used for excavation purposes. The robotic platform 100 may thus be used for various purposes and have the main frame of the robotic platform 100 reconfigured accordingly. Various payloads may be included in the dual track system with the protected bay, such as an excavation-related payload.

As shown in FIG. 11, when used for excavation surveying, the robotic platform 100 may additionally or alternatively include a payload 140A related to excavation. The payload 140A may include a second sensor assembly 220 configured to measure properties of rock in order to identify usable rock only. For example, the second sensor assembly 220 may include a plurality of sensors, non-limiting examples of which include hyperspectral sensors, a laser-induced breakdown spectroscopy (LIB S) analyzer, and/or an x-ray fluorescence (XFR) analyzer. The payload 140A may include an articulated arm 224 capable of rotation about one or more points. The articulated arm 224 may rotate to survey the rock that is being considered for excavation. In embodiments, where the robotic platform 100 has a payload 140A including an articulated arm 224, the robotic platform 100 may not use its flip-over capability.

The robotic platform 100 is thus capable of being adapted depending on the intended use of a specific robotic platform. In other examples, sensors from the sensor assembly 160 may be added or removed to account for the intended tasks of the robotic platform.

### Example User Interfaces

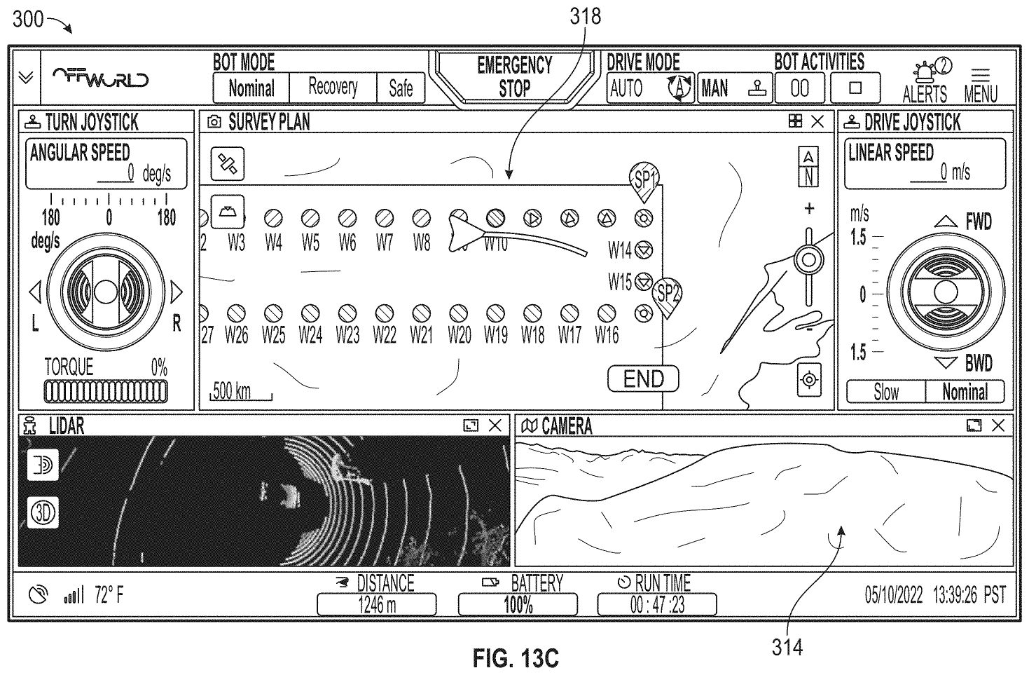

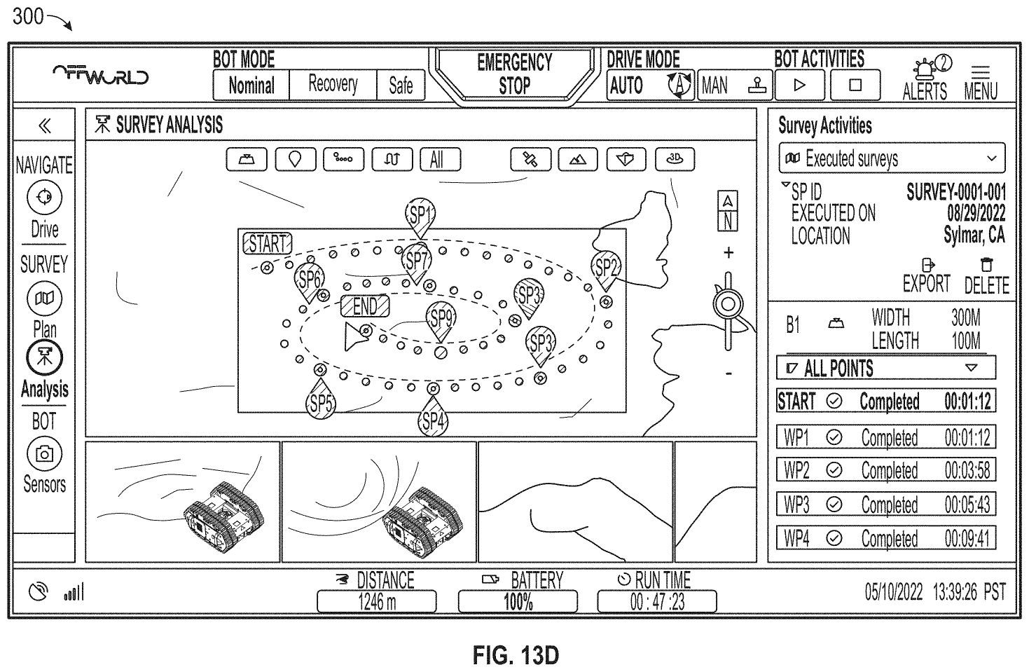

FIGS. 12-13D show example embodiments of user interfaces 300 for operating and/or monitoring the robotic platform 100. In some embodiments, the user interfaces 300 may be visible to a user through the use of a tablet or computer, for example, as shown in FIG. 12. The robotic platform 100 may be controlled via the screen of the device, or the device may be plugged into a separate physical controller.

As shown in FIG. 12 the tablet or computer may be operated by a handheld controller 304. The user interface 300 may have a Wi-Fi connection to the robotic platform and may include intuitive display with full robotic platform operational situational awareness. The user interface 300 may be capable of providing full data analytics on the robotic platform's health. The handheld controller 304 may include one or more ergonomic joysticks 306 capable of enabling manual control. The handheld controller 304 may include a stop button 308. In embodiments, without the handheld controller 304, a user may utilize a touch screen of the user interface 300. The controller 304 may be agnostic to various types of electronic tablets or phones, such that the controller 304 is configured to receive and control different devices that are plugged into the controller 304.

In some embodiments, the robotic platform 100 may be controlled via the screen of the electronic device. With reference to FIG. 13A, the user interface 300 of the electronic device may include a first joystick 310 for forward and backward drive and a second joystick 312 for left and right drive. The separate joysticks can allow for the user to avoid accidently causing the robotic platform 100 to rotate-clockwise and counter-clockwise when intending to move the robotic platform 100 forward and backward and from accidently causing the robotic platform 100 to move forward and backward when intending to rotate the robotic platform 100 clockwise or counter-clockwise with speed and torque feedback. The user interface 300 may include a live stream 314 from any of the cameras positioned on the robotic platform. A user may switch the live stream being shown between any of the cameras. The user interface 300 may include a visual representation 316 of the real time mapping reconstructions and visualization for full situational awareness, for example, through the LiDAR data being collected. The user interface 300 may include a visual representation 318 of a survey plan. The visual representation 318 may include GPS localization and survey tracking.

What is being displayed on the user interface 300 may be adjusted by the user. For example, with reference to FIG. 13B, a user may enlarge the visual representation 318 of the survey plan. This may be beneficial when a user is attempting to plan a survey. The user can create a plan for the robotic platform 100 prior to the robotic platform going to a predetermined site. The user can create a boundary 320 and define a path 324 within that boundary for the robotic platform 100 to follow. The survey plan can be adjusted during operations.

With reference to FIG. 13C, a user may change positioning of the various visual representations. In FIG. 13C the visual representation 318 has been enlarged and centralized, while the live stream 314 has been minimized and moved to the lower right corner. The user can monitor the survey path in the visual representation 318 while still viewing the live stream 314. Additionally, the user interface 300 may include emergency stop, safety and progress alerts, battery level, progress of the survey and other visual cues to allow the user to supervise and intervene if needed. With reference to FIG. 13D, a user can analyze a survey after the survey is completed. For example, the user can adjust the user interface 300 as needed to view the collected data (e.g., images, 3D maps) for analysis.

The systems, devices and methods for any of the embodiments of the robotic platform 100 described and shown herein may include any of the features or functionalities of the various industrial robotic platforms, or be used in any of the associated swarm systems, as described in U.S. Publication No. 2021/0114219A1 titled “SYSTEMS AND METHODS FOR INDUSTRIAL ROBOTICS”, filed on Oct. 14, 2020 and in U.S. Publication No. 2021/0116889A1 titled “INDUSTRIAL ROBOTIC PLATFORMS”, and filed on Oct. 14, 2020 the entirety of each of which is incorporated by reference herein for all purposes and forms a part of this specification.

### CONCLUSION

Various modifications to the implementations described in this disclosure will be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “example” is used exclusively herein to mean “serving as an example, instance, or illustration.” Any implementation described herein as “example” is not necessarily to be construed as preferred or advantageous over other implementations, unless otherwise stated.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Additionally, other implementations are within the scope of the following claims. In some cases, the actions recited in the claims may be performed in a different order and still achieve desirable results.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. A robotic platform comprising:
a dual track dual suspension-tension system comprising a first track extending longitudinally and positioned along a first lateral side of the robotic platform and a second track extending longitudinally and positioned along a second lateral side of the robotic platform, each track extending over a respective plurality of rollers;
a first body extending laterally and connecting the first track and the second track at a forward end of the robotic platform;
a second body extending laterally and connecting the first track and the second track at a rear end of the robotic platform, wherein the first body, the second body, the first track and the second track define a payload bay; and
a payload support configured to carry a payload, the payload support mounted in the payload bay of the robotic platform, the payload support mounted to each of the first body and the second body with a gimbaled mount configured to rotate the payload in at least two axes as the robotic platform changes orientation.

2. The robotic platform of claim 1, wherein the payload support is accessible from a first direction above a horizontal plane extending through the payload bay and from a second direction below the horizontal plane.

3. The robotic platform of claim 1, wherein the payload bay is protected by the first lateral side, the second lateral side, the first body, and the second body and wherein a first exposed side of the payload bay faces in a direction opposite to an upward vertical axis.

4. The robotic platform of claim 1, wherein the payload support comprises a protective transparent cover configured to protect the payload.

5. The robotic platform of claim 1, wherein the gimbaled mount is rotationally coupled about a longitudinal axis of the robotic platform at rotational connections with the first body and the second body.

6. The robotic platform of claim 5, further comprising the payload, wherein the payload is rotationally coupled about a lateral axis that is perpendicular to the longitudinal axis of the robotic platform.

7. The robotic platform of claim 1, further comprising the payload, wherein the payload comprises a LiDAR sensor.

8. The robotic platform of claim 1, wherein the robotic platform is configured to operate in a first orientation and a second orientation, wherein in the first orientation a vertical vector of the robotic platform that is perpendicular to the longitudinal and lateral directions has a component parallel with and in the same direction as a gravity vector, and in the second orientation the vertical vector has a component parallel with and in the opposite direction as the gravity vector.

9. The robotic platform of claim 8, wherein the robotic platform rotates 180 degrees about a longitudinal axis to transition from the first orientation to the second orientation.

10. The robotic platform of claim 8, wherein the robotic platform flips to transition from the first orientation to the second orientation.

11. The robotic platform of claim 1, wherein the gimbaled mount is configured to actively rotate.

12. The robotic platform of claim 1, wherein the gimbaled mount is configured to passively rotate.

13. A robotic platform comprising:
a dual track dual suspension-tension system comprising a first track extending longitudinally and positioned along a first lateral side of the robotic platform and a second track extending longitudinally and positioned along a second lateral side of the robotic platform, each track extending over a respective plurality of rollers; and
a symmetrical sensor assembly configured to operate according to a reference frame, the reference frame controlled via a control system,
wherein the control system inverts the reference frame when the robotic platform transitions from a first orientation to a second orientation, wherein in the first orientation a vertical vector of the robotic platform that is perpendicular to the longitudinal and lateral directions has a component parallel with and in an opposite direction as a gravity vector, and in the second orientation the vertical vector has a component parallel with and in a same direction as the gravity vector.

14. The robotic platform of claim 13, wherein the symmetrical sensor assembly further comprises a plurality of sensors symmetrically positioned about the robotic platform with respect to a horizontal plane.

15. The robotic platform of claim 13, wherein the symmetrical sensor assembly further comprises a LiDAR sensor mounted on a tilting platform on a first body extending laterally and connecting the first track and the second track at a forward end of the robotic platform or a second body extending laterally and connecting the first track and the second track at a rear end of the robotic platform.

16. The robotic platform of claim 13, wherein the symmetrical sensor assembly further comprises a first camera mounted to a first body extending laterally and connecting the first track and the second track at a forward end of the robotic platform and a second camera mounted to a second body extending laterally and connecting the first track and the second track at a rear end of the robotic platform.

17. The robotic platform of claim 13, wherein the symmetrical sensor assembly further comprises a first camera mounted to the first lateral side and a second camera mounted to the second lateral side.

18. The robotic platform of claim 13, wherein the symmetrical sensor assembly further comprises a camera configured to view a payload bay.

19. A robotic platform comprising:
a dual track dual suspension-tension system comprising a first track extending longitudinally and positioned along a first lateral side of the robotic platform and a second track extending longitudinally and positioned along a second lateral side of the robotic platform, each track extending over a respective plurality of rollers; and
a plurality of suspension arms coupled to groups of the respective plurality of rollers, wherein a first vertical end of at least one of the plurality of suspension arms is positioned on a ground-facing side of the tracks and a second vertical end of at least one of the plurality of suspension arms is positioned on a non-ground-facing side of the tracks,
wherein the robotic platform is configured to operate in a first orientation and a second orientation, wherein in the first orientation a vertical vector of the robotic platform that is perpendicular to the longitudinal and lateral directions has a component parallel with and in the same direction as a gravity vector, and in the second orientation the vertical vector has a component parallel with and in the opposite direction as the gravity vector.

20. The robotic platform of claim 19, wherein the plurality of rollers are configured to be tensioned on robotic platform h the ground-facing side of the tracks and the non-ground-facing side of the tracks.

21. The robotic platform of claim 19, wherein the groups of the plurality of rollers comprise pairs of rollers, each pair of rollers coupled to one of the plurality of suspension arms.

22. The robotic platform of claim 21, wherein each suspension arm is coupled to a shock absorber.

23. The robotic platform of claim 21, wherein each pair of rollers comprises a first roller rotatably coupled to a first end of a curved connector and a second roller rotatably coupled to a second end of the curved connector, the curved connector moveably coupled to a suspension arm.

24. The robotic platform of claim 23, wherein each group of rollers is capable of independent movement.

25. The robotic platform of claim 19, further comprising a motor configured to operate the dual track dual suspension-tension system.
